(19) United States
(12) Patent Application Publication
(10) Pub. No.: US 2011/0194426 A1
(43) Pub. Date: Aug. 11, 2011

(54) HIERARCHICAL QUEUING AND SCHEDULING

(76) Inventors: Chien FANG, Danville, CA (US); Hiroshi Suzuki, Palo Alto, CA (US); Rong Pan, Sunnyvale, CA (US); Abhijit Kumar Choudhury, Cupertino, CA (US); David Sheldon Stephenson, San Jose, CA (US); Surendra Anubolu, Fremont, CA (US); Hariprasad R. Ginjpalli, Cupertino, CA (US); Stanley WaiYip Ho, Millbrae, CA (US); Peter Geoffrey Jones, Campbell, CA (US)

(21) Appl. No.: 12/702,826

(22) Filed: Feb. 9, 2010

(51) Int. Cl. H04L 12/56

(52) U.S. Cl. 370/252; 370/412

(57) ABSTRACT

In an example embodiment, there is disclosed herein logic encoded in at least one tangible media for execution and when executed operable to receive a packet. The logic determines a client associated with the packet. The client associated with a service set, and the service set associated with a transmitter. The logic determines a drop probability for the selected client determines a current packet arrival rate for the selected client and determines whether to enqueue or drop the packet based on the drop probability for the selected client and the current packet arrival rate associated with the selected client. The drop probability is based on a packet arrival rate and virtual queue length for the, which is based on a packet arrival rate and virtual queue length for the service set that is based on a packet arrival rate and virtual queue length for the transmitter.

### TECHNICAL FIELD

The present disclosure relates generally to Hierarchical Queuing and scheduling (HQS)

### BACKGROUND

Approximate Fair propping (AFD) is an Active Queue Management (AQM) scheme for approximating fair queuing behaviors. AFD uses packet accounting and probabilistic packet discard to achieve a desired bandwidth differentiation. Differentiated packet drop schemes such as AFD can approximate fair bandwidth sharing but are poor at enforcing shaping rates. Conversely, hierarchical policing schemes can approximate shaping behaviors but are poor at fair bandwidth sharing.

### BRIEF DESCRIPTION OF THE DRAWINGS

The accompanying drawings incorporated herein and forming a part of the specification illustrate the examples embodiments.

FIG. 1 is a block diagram illustrating an example of a system comprising a Hierarchical Queue Scheduler and a Queue.

FIG. 2 is a detailed block diagram illustrating an example of a system comprising a Hierarchical Queue Scheduler and a Queue that further illustrates an example of modules/counters employed by a Hierarchical Queue Scheduler.

FIG. 3 is a block diagram illustrating an example wireless system comprising a transmit queue with associated transmitters, service sets and clients.

FIG. 4 is a block diagram illustrating an example wireless system with real time and non-real time queues.

FIG. 5 illustrates an example of a method for determining whether to enqueue or drop a packet for a queue employing hierarchical queue scheduling.

FIG. 6 illustrates an example of a method for determining a drop probability for a wireless system employing hierarchical queue scheduling.

FIG. 7 illustrates an example of a logical block diagram of a wired port system employing hierarchical queuing and scheduling for determining fair share bandwidths for each Class of Service.

FIG. 8 illustrates an example of a method for determining a drop probability for a wired port system employing hierarchical queue scheduling.

FIG. 9 illustrates an example of a method for determining whether to enqueue or drop a packet for a queue employing hierarchical queue scheduling.

FIG. 10 illustrates a computer system upon which an example embodiment can be implemented.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein, a method comprising determining a bandwidth for a queue. Bandwidth is allocated to first and second transmitters coupled to the queue, wherein the bandwidth allocated to each of the first and second transmitters is a portion of the queue bandwidth. A bandwidth allocation is determined for a first plurality of clients associated with the first transmitter, wherein the bandwidth allocated to each of the first plurality of clients is a portion of the bandwidth allocated to the first transmitter. A bandwidth allocation is determined for a second plurality of clients associated with a second transmitter, wherein the bandwidth allocated to each of the second plurality of clients is a portion of the bandwidth allocated to the second transmitter. Packet arrival counts are maintained for each of the first plurality of clients and second plurality of clients. A drop probability is determined for each of the first plurality of clients and the second plurality of clients based on the packet arrival count corresponding to each client and bandwidth allocated for each client.

In accordance with an example embodiment, there is disclosed herein, logic encoded in at least one tangible media for execution. The logic when executed is operable to receive a packet, determine a client associated with the packet, the client selected from a plurality of clients, the selected client belonging to a service set selected from a plurality of service sets, the service set belonging to a transmitter selected from a plurality of transmitters, and the plurality of transmitters sharing a queue. The logic determines a drop probability for the selected client and a current packet arrival rate for the selected client. The logic determines whether to enqueue or drop the packet based on the drop probability for the selected client and the current packet arrival rate associated with the selected client. The drop probability is based on a packet arrival rate and virtual queue length for the selected client, which is based on a packet arrival rate and virtual queue length for the selected service set that is based on a packet arrival rate and virtual queue length for the selected transmitter.

In accordance with an example embodiment, there is disclosed herein, an apparatus comprising a queue and hierarchical queue scheduling logic coupled to the queue. The hierarchical queue scheduling logic is configured to maintain arrival counts by transmitter, service set and client for packets received for the queue. The hierarchical queue scheduling logic is configured to allocate a bandwidth for at least one transmitter servicing the queue based on a packet arrival count for packets received for the at least one transmitter and changes to queue occupancy. The hierarchical queue scheduling logic is configured to determine a bandwidth allocation for at least one service set associated with the at least one transmitter, the bandwidth allocation for the at least one service set is based on a virtual queue length for the at least one transmitter. The hierarchical queue scheduling logic is configured to determine a bandwidth allocation for at least one client associated with the at least one service set based on a virtual queue length for the at least one service set, wherein the hierarchical queue scheduling logic is configured to determine a client drop probability for the at least one client based on a packet arrival rate for the at least one client and bandwidth allocation for the at least one client.

In accordance with an example embodiment, there is disclosed herein, logic encoded in at least one tangible media and when executed operable to determine a bandwidth for a queue coupled to the logic. The logic, employing a hierarchical queuing technique, determines a fair share bandwidth for each Class of Service associated with the queue by calculating fair share bandwidths for each Virtual Local Area Network coupled to the queue, where the fair share bandwidth of each Virtual Local Area Network is based on a weighting factor and the bandwidth of the queue. The logic further determines for each Virtual Local Area Network a fair share bandwidth for each Class of Service associated with each Virtual local area network, wherein the fair share bandwidth of each Class of Service is a portion of the fair share bandwidth of its associated Virtual Local Area Network.

In accordance with an example embodiment, there is disclosed herein, a method comprising determining a reference queue length for a queue and a queue length for the queue. A first virtual queue length is determined for a first Virtual Local Area Network coupled to the queue. A first reference virtual queue length is determined for the first Virtual Local Area Network. A second virtual queue length is determined for a second Virtual Local Area Network coupled to the queue. A second reference virtual queue length is determined for the second Virtual Local Area Network. A maximum rate is determined for a Class of Service associated with the first Virtual Local Area Network. A current packet arrival rate is determined for the Class of Service, and a drop probability is determined for the Class of Service based on the packet arrival rate and maximum rate for the class of service.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment, multiple, cascading stages comprising dropping algorithms (such as approximate fair dropping “AFD”, a weighted dropping algorithm, or any suitable dropping algorithm) are employed to build a hierarchy. A virtual drain rate and/or a virtual queue length can be employed by each stage's processing algorithm. The hierarchy can be employed for wireless Quality of Service (QoS) support and/or wired port Group/Class of Service (CoS) support.

in an example embodiment, there are three levels in the wireless QoS hierarchy: radio, service set, and client. In the first stage, a dropping algorithm for the radio uses the physical queue length to calculate Radio (transmitter) fair share bandwidth. The Radio hierarchy is shaped as the radio bandwidth capacity is limited. The second stage dropping algorithm is for service sets associated with each radio. The second stage uses the Radio stage's virtual queue length to calculate service set fair share bandwidths. The Radio virtual queue length is calculated based on the virtual shaping rate of the Radio flow. In particular embodiments, shaping at the service set level are optional, radio bandwidth may be shared by all service sets in a weighted manner and some service sets may be capped at configured maximum rates. The third stage dropping algorithm is for the Client and uses the service set stage's virtual queue length to calculate client fair share bandwidth. The service set virtual queue length can be calculated based on the virtual drain rate of the service set flow. Each client can share the service set bandwidth evenly, or can be rate limited to configurable maximum rates.

In a wired port application, the hierarchy can be two levels, Group, and Class of Service (CoS). The Group level can be any supported feature such as Virtual Local Area Network (VLAN), Multiprotocol Label Switching (MPLS), Virtual Ethernet Line, etc. The Cos level may correspond to the Cos bits of Layer 2 (L2) frames.

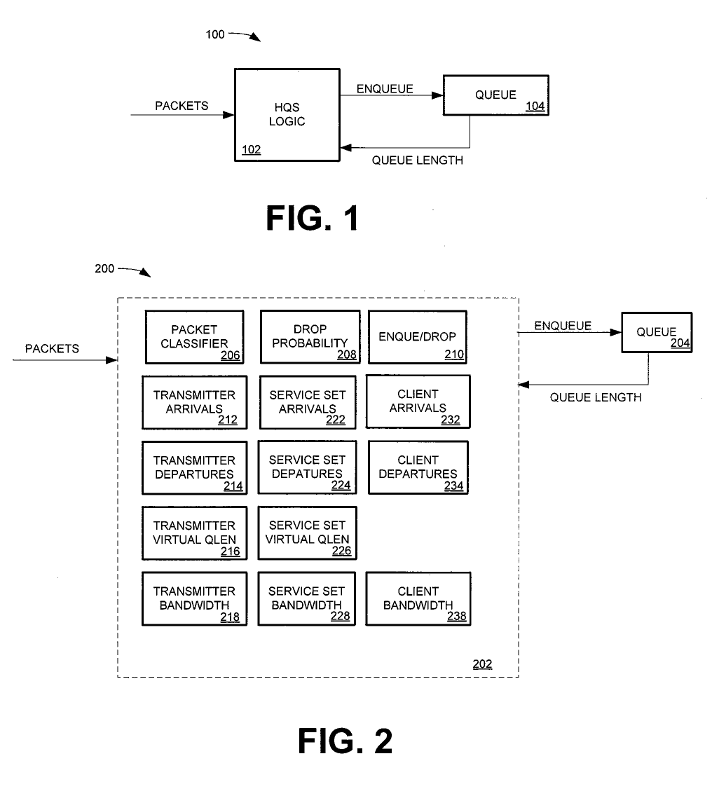

FIG. 1 is a block diagram illustrating an example of system 100 employing Hierarchical Queue Scheduler (HQS) logic 102 and a Queue 104. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software. In example embodiments, logic may comprise modules configured to perform one or more functions.

HQS logic 102 is configured to receive a packet and determine from the packet, a client for the packet associated with queue 104. The client may suitably be associated with a service set (identified by a service set identifier or “SSID”) and with a transmitter associated with queue 104. In this example the transmitter is a wireless transmitter although those skilled in the art should readily appreciate the principles described herein are also applicable to wired environments which will be illustrated in other example embodiments presented herein infra. In some example embodiments, clients are associated with a transmitter and not a service set, and in other embodiments some clients are associated with service sets while other clients are not associated with service sets.

HQS logic 102 is configured to determine a drop probability for the client, a current packet arrival rate for the selected client and whether to enqueue or drop the packet based on the drop probability for the selected client and the current packet arrival rate associated with the selected client. The drop probability is based on a packet arrival rate and virtual queue length for the selected client, which is based on a packet arrival rate and virtual queue length for the selected service set that is based on a packet arrival rate and virtual queue length for the selected transmitter.

In an example embodiment, a set of counters (see e.g. FIG. 2) are maintained by HQS logic 102 that includes arrival rates, fair share bandwidths, and drop probabilities, at each level of the hierarchy (client/service set/transmitter). A measurement interval can be defined, during which arrival counts for all traffic flows are recorded. At the end of the interval, various counters such as the average arrival rates, fair share bandwidth and enqueue/drop probabilities are updated based on the arrival counts in that interval. The updated counters are used for incoming packets in the next interval, while the arrival counts are reset and used to record arrivals in the next interval. The update calculations start from the 1^{st}-stage (transmitter) and then proceed to 2^{nd}-stage (service set if applicable) and the 3^{rd}-stage (client).

For example, in an example embodiment, HQS logic 102 maintains a counter for determining the packet arrival rate for the client. HQS logic 102 updates the counter for the client responsive to receiving the packet. In an example embodiment, HQS logic 102 also maintains packet arrival counters for the transmitter (and if applicable the service set) associated with the client. HQS logic 102 updates these counters as appropriate.

In an example embodiment, HQS logic 102 is configured to determine a change in queue length (occupancy of queue 104) over a period of time. HQS logic 102 also determines the packet arrival rate for the queue over the period. HQS logic 102 is configured to determine a bandwidth for the transmitter based on the queue length which is adjusted based on changes in queue length (e.g., increases/decreases in queue occupancy). HQS logic 102 is further configured to determine a virtual queue length for the transmitter based on packet arrivals and departures (e.g. transmitter fair share bandwidth).

In an example embodiment, HQS logic 102 is further configured to calculate service set fair share bandwidths based on transmitter virtual queue and to adjust the service set fair share bandwidths based on changes to the transmitter virtual queue. HQS logic 102 calculates virtual queue lengths for a service set based on packet arrivals for the service set and virtual departures from the service set (e.g. the service set fair share bandwidth).

HQS logic 102 determines client fair share bandwidths based on the service set virtual queue. The client fair share bandwidths are adjusted based on changes to the service set virtual queue. Average client arrival rates can be calculated based on time-window averaging. Client drop probabilities can be calculated from the average client arrival rates and client fair share bandwidth (or rate). If the arrival rate is below the fair share rate (and if configured the configured maximum client rate) then the drop probability is zero. If the average arrival rate is more than the fair share rate (and/or maximum configured rate), the drop probability is proportional to the amount the average arrival rate is in excess of the fair share rate (or maximum configured rate).

In an example embodiment, when a packet is received, HQS logic 102 determines the appropriate client for the packet and updates the packet arrival counter for the client. If there are no buffers available for the packet, the packet is then (tail) dropped. HQS logic 102 then determines from the client drop probability whether to drop the packet. If the packet is not dropped, the counters for the transmitter (and if applicable service set) are updated and the packet is enqued into queue 104. In particular embodiments, HQS logic 102 maintains virtual queue lengths for each stage and may drop packets at the service set or transmitter stage based on their respective virtual queue lengths.

In accordance with an example embodiment, HQS logic 102 eliminates the need for additional queues and schedulers to support hierarchies and classes. HQS logic 102 can support both hierarchical shaping and hierarchical fair share bandwidth allocation. HQS logic 102 can implement both hierarchical shaping and hierarchical fiar share bandwidth by employing counters and periodic processing which may be performed in the background.

FIG. 2 is a detailed block diagram illustrating an example of modules 206, 208, 210, 212, 214, 216, 218, 222, 224, 226, 228, 232, 234, 236, 238 that can be employed by a system 200 comprising a Hierarchical Queue Scheduler (HQS) logic 202 and a Queue 204. In accordance with an example embodiment, HQS logic 202 can implement the functionality described herein for HQS logic 102.

Packet classifier 206 determines the appropriate client (if applicable service set) and transmitter for incoming packets destined for queue 204. The drop probability for the appropriate client is maintained by drop probability module 208. Enque/prop module 210 determines whether the packet should be enqueued or dropped.

Transmitter arrivals module 212 may suitably be a counter that is incremented whenever a packet is forwarded to a transmitter for transmission. Transmitter departures module 214 maintains a count of packets that were actually transmitted during a time period. Transmitter virtual queue length (QLEN) module 216 determines the virtual queue length for the transmitter. Transmitter bandwidth module 218 determines the allocated bandwidth for the transmitter.

Service set arrivals module 222 may suitably be a counter that is incremented whenever a packet is forwarded to a service set for transmission. Service set departures module 224 maintains a count of packets that were actually transmitted during a time period. Service set virtual queue length (QLEN) module 226 determines the virtual queue length for the service set. Service set bandwidth module 228 determines the allocated bandwidth for the service set.

Client arrivals module 232 may suitably be a counter that is incremented whenever a packet is forwarded to a client for transmission. Client departures module 234 maintains a count of packets that were actually transmitted during a time period. Client bandwidth module 238 determines the allocated bandwidth for the client.

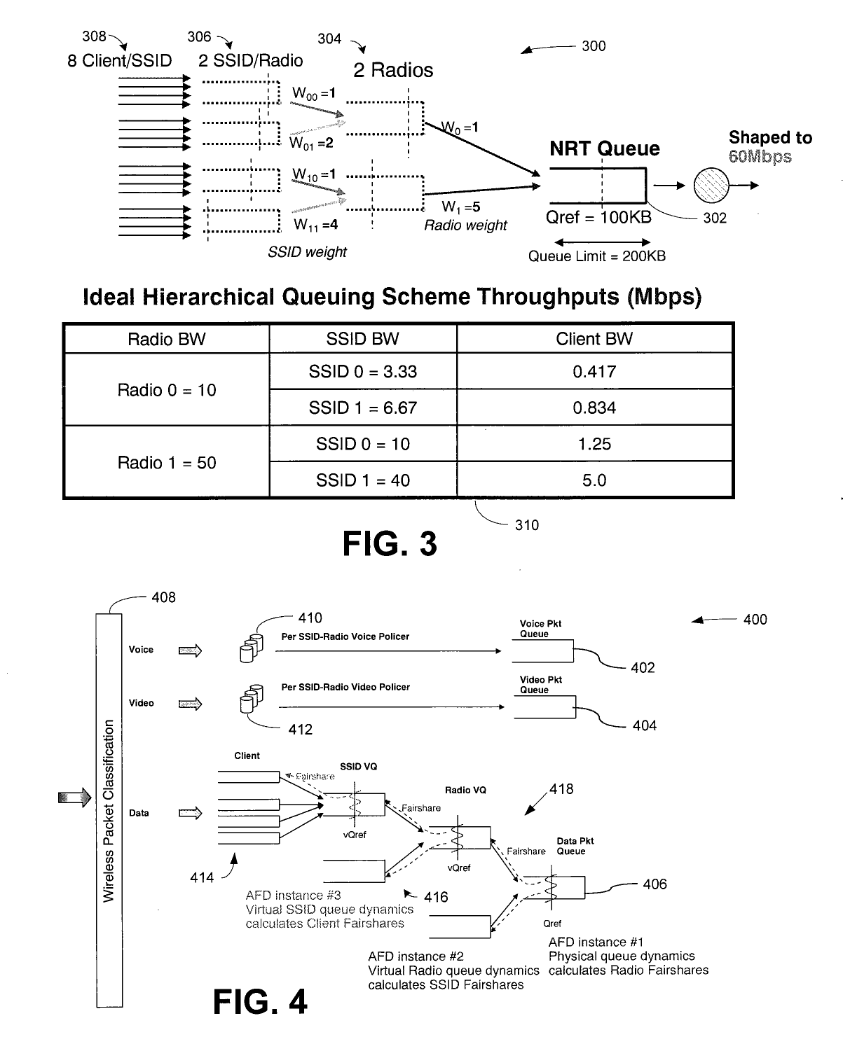

FIG. 3 is a block diagram illustrating an example system 300 comprising a transmit queue 302 with associated transmitter stage 304, service set stage 306 and client stage 308. In the illustrated example, transmitter stage 304 comprises two radios (wireless transmitters), service set stage 306 comprises four service sets (two per radio) and client stage 308 comprises thirty-two clients (eight per service set). Those skilled in the art should readily appreciate that these numbers were picked arbitrarily and merely for ease of illustration as a hierarchical queue scheduling system as described herein may have any physically realizable numbers of radios, service sets and clients.

In this example queue 302 is shaped to 60 Mbps. Queue 302's limit is 200 KB and a reference queue length (Qref) of 100 KB is selected. The first radio W0 is allocated ⅙ of the queue's bandwidth and second radio W1 is allocated ⅚ of the queue's bandwidth. Service set W00 is allocated ⅓ of the first radio's bandwidth and service set W01 is allocated ⅔ of the first radio's bandwidth. Service set W10 is allocated ⅕ of the second radio's bandwidth and service set W11 is allocated ⅘ of the second radio's bandwidth. Half of the clients associated with each service set are configured with a maximum bandwidth of 12.5 Mbps and the other half of the clients are allocated a maximum bandwidth of 25 Mbps. In the illustrated example there are eight clients (four at 12.5 Mbps and four at 25 Mbps) per service set for a total of thirty-two clients. The bandwidth allocations of radios W0, W1, service sets W00, W01, W10, W11 and clients (not labeled) are configurable.

Table 310 illustrates an initial setting for the radios, service sets and clients for this example. The bandwidths are allocated hierarchically beginning at the radios, so the bandwidth allocated for the first radio, W0, is ⅙ of 60 Mbps or 10 Mbps. The bandwidth allocated for the second radio, W1, is ⅚ of 60 Mbps or 50 Mbps.

After the bandwidths for transmitter stage 304 are computed, the bandwidths for service set stage 306 are computed. In this example, Service Set W00 gets ⅓ of the bandwidth allocated to the first radio, 3.33 Mpbs. Service Set W01 gets ⅔ of the bandwidth allocated to the first radio, 6.67 Mpbs. Service Set W10 gets ⅕ of the bandwidth allocated to the second radio, 10 Mpbs. Service Set W11 gets ⅘ of the bandwidth allocated to the second radio, 40 Mpbs.

After the bandwidths for service set stage 306 are computed, the bandwidths for client stage 308 are computed. Since there are 8 clients per service set, clients associated with service set W00 are allocated 0.417 Mbps, clients associated with service set W01 are allocated 0.834 Mbps, clients associated with service set W10 are allocated 1.25 Mbps, and clients associated with service set W11 are allocated 5.0 M bps (note that all of these bandwidths are below the maximum configured bandwidths for the clients). Client drop probabilities are based on the allocated bandwidths and packet arrival rates for each client.

In accordance with an example embodiment, as the queue length (queue occupancy) of queue 302 exceeds Reference queue length (Qref), the bandwidth allocations for radios W0, W1, service sets W00, W01, W10, W11, and their associated clients are adjusted accordingly.

FIG. 4 is a block diagram illustrating an example system 400 with real time (RT) 402, 404 queues and non-real time (NRT) 406 queues. In the illustrated example, real time queue 402 is a voice packet queue and real time queue 404 is a video packet queue. Non-real time queue 406 is a data packet queue. Configurations such as are illustrated in FIG. 4 may be employed by wireless access points (APs).

In the illustrated example, packets are received and processed by wireless packet classification module 408. Wireless packet classification module determines 408 whether an incoming packet is a voice, video or data packet. In an example embodiment, wireless packet classification module 408 determines a client, service set, and radio for data packets. Voice packets are routed to a voice packet policing module 410, and if not dropped enqueued into queue 402. Video packets are routed to a video packet policing module 412, and if not dropped enqueued into queue 404.

Data packets are processed by hierarchical queue scheduling logic as described herein. The hierarchical scheduling logic determines the physical queue dynamics of queue 406 and calculates radio fairshares (fair share bandwidth) for the radios in stage 418. The fairshares may be based on the current queue length and the reference queue length. The hierarchical scheduling logic may calculate a virtual queue and a virtual queue reference (VQref) for each radio. Service set fairshares for the service sets in stage 416 are calculated based on the virtual queue dynamics of their associated radios. A virtual queue and virtual queue reference may be computed for each service set. Client fairshares, in stage 414, are computed based on the virtual queue dynamics for their associated service sets. Client drop probabilities can be determined based on client fairshare and the packet arrival rate for the client.

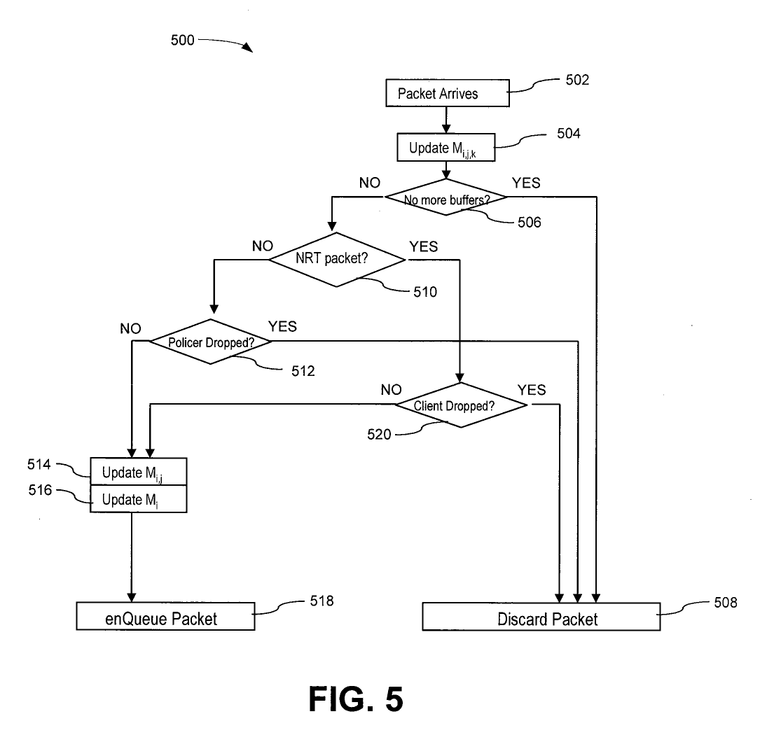

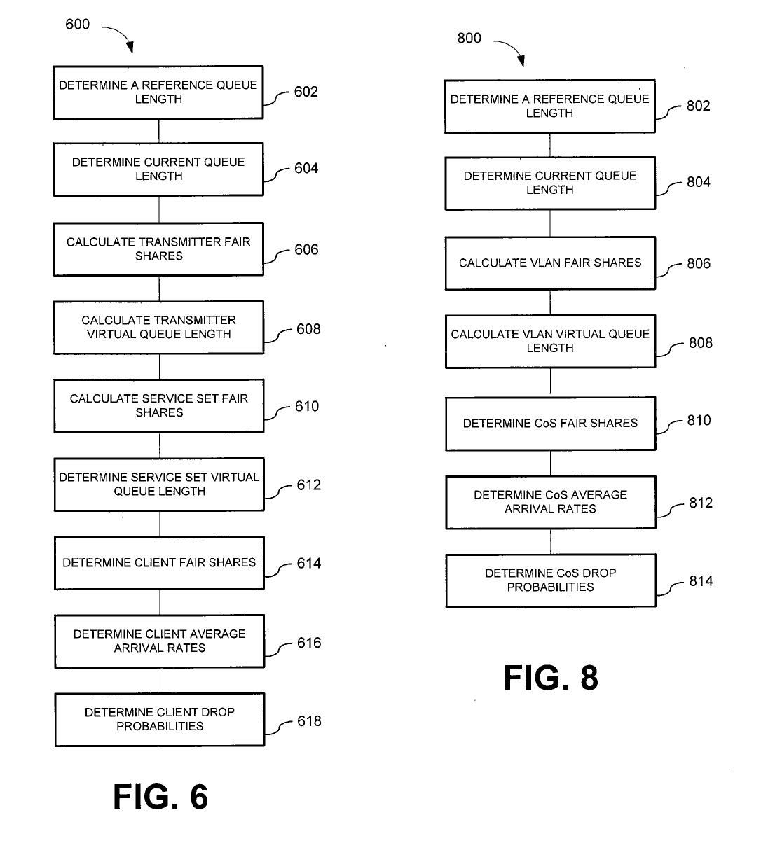

In view of the foregoing structural and functional features described above, methodologies in accordance with example embodiments will be better appreciated with reference to FIGS. 5 and 6. While, for purposes of simplicity of explanation, the methodologies of FIGS. 5 and 6 are shown and described as executing serially, it is to be understood and appreciated that the example embodiments are not limited by their illustrated orders, as some aspects could occur in different orders and/or concurrently with other aspects from that shown and described herein. Moreover, not all illustrated features may be required to implement the methodologies described herein in accordance with aspects of example embodiments. The methodologies described herein are suitably adapted to be implemented in hardware, software, or a combination thereof.

FIG. 5 illustrates an example of a method 500 for determining whether to enqueue or drop a packet for a queue employing hierarchical queue scheduling. Methodology 500 is suitable to be implemented on an apparatus having real time and non-real time queues such as apparatus 400 illustrated in FIG. 4.

At 502, a packet arrives. The packet may be a real time (RT) packet or non-real time (NRT) packet. Packet classification logic determines the type of packet (real time or non-real time) and a client, service set and/or transmitter (radio) for sending the packet.

At 504, a counter associated with the client for the packet is updated. In the illustrated example, the counter is Mijk, where i=the radio, j=the service set (or SSID) for radio i, and k=the kth client of the jth service set of radio i. The counters can be employed for determining client packet arrival rates.

At 506, a determination is made whether there are available buffers for the packet (No more buffers?). If there are no buffers (YES), at 508 the packet is discarded (dropped). If there are buffers (NO), at 510 a determination is made whether the packet is a non-real time (NRT) packet.

If, at 510, a determination is made that the packet is not a non-real time packet (NO), or in other words the packet is a real time packet, at 512 the packet is forwarded to the appropriate policer for the queue for transmitting the packet. For example, in FIG. 4 if the packet is a voice packet it would be processed by voice policer 410, or if the packet was a video packet it would be processed by video policer 412. If the policer drops the packet (YES), the packet is discarded as illustrated by 508.

If, at 512, the packet is not dropped by the policer (NO), at 514, a counter for the service set associated with the packet is updated (Mij) and at 516 a counter for the transmitter (radio, Mi) is updated. Counters Mij and Mi enable packet rates to be determined for the service set and radio respectively. At 518, the packet is enqueued.

If at 510, the packet is determined to be a non-real time packet (YES), at 520 a determination is made as to whether to client drop the packet. The client drop can be determined by the arrival packet rate and drop probability for the client associated with the packet. In an example embodiment, hierarchical queuing and scheduling as described herein is employed to determine whether to client drop the packet. In an example embodiment, virtual queues and queue lengths are computed for the radio and service set for determining the drop probability for the client.

If, at 520, the packet is client dropped (YES), at 508 the packet is discarded. If, at 520, the packet is not client dropped (NO), at 514, a counter for the service set associated with the packet is updated (Mij) and at 516 a counter for the transmitter (radio, Mi) is updated. Counters Mij and Mi enable packet rates to be determined for the service set and radio respectively. At 518, the packet is enqueued.

FIG. 6 illustrates an example of a method 600 for determining a drop probability for a system employing hierarchical queue scheduling. Method 600 determines drop probabilities by determining virtual queue properties based off of the physical queue condition for a plurality of stages. In this example, method 500 determines virtual queue properties for three stages, a transmitter (radio) stage, a service set stage, and a client stage. Those skilled in the art should readily appreciate, however, that the number of stages selected may be any physically realizable number. For example, for embodiments where clients are not associated with a service set, there may only be two stages, and the client fair shares (as will be described herein infra, computed at 614) may be based on the radio fair shares instead of the service set fair shares. Methodology 600 is suitable for allocating bandwidths as was described for FIG. 3. Methodology 600 may be periodically executed to account for changes in the physical queue and/or update client drop probabilities.

At 602, a reference queue length is determined for the physical queue. The reference queue length may be a default length (such as 50% of the total queue size) or may be a configurable value. In addition, a queue bandwidth may be determined.

At 604, the current queue length is determined. As used herein, the current queue length refers to the amount of space in the queue that is occupied (for example a number of bytes or % of the total queue that is occupied).

At 606, transmitter (e.g., radio) fair shares (fair share bandwidth) are calculated. The fair shares are a function of the occupancy of the physical queue. For example, as queue occupancy increases, transmitter fair shares decreases.

At 608, transmitter virtual queue lengths are calculated. Transmitter virtual queue length may be calculated from actual arrivals and departures (e.g. fair share bandwidth)

At 610, service set fair shares are calculated. The service set fair shares are a function of the radio virtual queue. In particular embodiments, a weighting algorithm may be employed for determining the service set fiar shares (for example a first service set may get ⅓ of the available bandwidth for the transmitter while the second service set may get ⅔ of available bandwidth).

At 612, service set virtual queue lengths are calculated. The service set virtual queue lengths may be based on actual service set arrivals and virtual service set departures (e.g. the service set bandwidth).

At 614, client fair shares are calculated. The client fair shares are a function of the service set that the client belongs. For example, a first client may receive ⅙ of the service set's fair share bandwidth while a second client may receive ⅚ of the service set's fair share bandwidth. Client fair shares can be calculated also based on changes to the service set virtual queue.

At 616, average client arrival rates are determined. The average client arrival rates can be calculated based on time-window averaging.

At 618, client probabilities are calculated. The client drop probabilities may be calculated form the average client arrival rates and client fare share rates. If the arrival rate is below the fair share rate, the drop probability is zero. If the prop average arrival rate is more than the minimum of the fair share rate or the configured maximum rate for the client, the drop probability is proportional to the amount that the average arrival rate is in excess of the minimum of the fair share rate or the configured maximum rate.

Below is an example of pseudo code for implementing a methodology in accordance with an example embodiment. In an example embodiment, the methodology is periodically executed (for example every 1.6 milliseconds). In this example, the variables are as follows:

UpdateInterval=1.6 msec.

Parameter C determines the rate averaging interval, i.e., 2^{C}×UpdateInterval.

For the physical queue:
QLen is the length (occupancy) of the queue;
QRef is a reference QLen for the queue;
Mfair^{C} is the common fair share rate;
Mmaxᵢ is the maximum shaped rate for the queue;

For the Radio virtual queue:
Wᵢ is the weight for the i^{th} radio;
Mᵢ is the arrival rate for the i^{th} radio;
Mfairᵢ is the fair share bandwidth (rate) for the i^{th} radio;
Mmaxᵢ is the Max rate for the i^{th} radio;
VQlenᵢ is the virtual queue length for the i^{th} radio;
VQrefᵢ is the reference virtual Qlen for the i^{th} radio;
Mfair^{C}ᵢ is the common fair rate f for the i^{th} radio;

For the Service Set (SSID) virtual queue:
W_{i,j} is the weight for j^{th} SSID of the i^{th} radio;
M_{i,j} is the arrival rate for j^{th} SSID of the i^{th} radio;
Mfair_{i,j} is the fair share bandwidth (rate) for the i^{th} radio;
Mmax_{i,j} is the Max rate for j^{th} SSID of the i^{th} radio;
VQlen_{i,j} is the virtual queue length for j^{th} SSID of the i^{th} radio;
VQref_{i,j} is the reference virtual Qlen for j^{th} SSID of the i^{th} radio;
Mfair^{C}_{i,j} is the common fair rate f for the j^{th} SSID of the i^{th} radio;

For clients:
M_{i,j,k} is the arrival rate for the k^{th} client of the j^{th} SSID of the i^{th} radio;
Mmax_{i,j,k} is the maximum rate for the k^{th} client of the j^{th} SSID of the i^{th} radio; and
D_{i,j,k} is the drop probability for the k^{th} client of the j^{th} SSID of the i^{th} radio.

The algorithm is as follows, first for the radio stage:

```
    Mfair^{C} = Mfair^{C} − (Qlen_total − Qref)/a1 −
    (Qlen_total − Qlen_total_old)/a2
    If (Mfair^{C} < 0) Mfair^{C} = 0
        if (tail_drop_occurred)
                Mfair^{C} = Mfair^{C} − Mfair^{C} >> fast_down
(a predefined constant, for example 6)
            else if (Qlen < Qmin)
              Mfair^{C} = Mfair^{C} + Mfair^{C} >> fast_up (a predefined
constant, for example 6)
        Mfairᵢ = Min { Mfair^{C} * Wᵢ , Mmaxᵢ}
```

For the service set (SSID) stage: parameter Settings
vQlenᵢ the calculated virtual Radio queue length is derived,
vQrefᵢ=W′ᵢ*Qref (W′ᵢ=normalized Wᵢ for computing vQrefᵢ);

For each SSID:

```
    vQlenᵢ = Max(0, vQlenᵢ + Mᵢ − (Mfairᵢ >> C)), where C is a
predefined parameter, typically set to 4.
    Mfair^{C}ᵢ = Mfair^{C}ᵢ − (vQlenᵢ − vQrefᵢ)/b1 − (vQlenᵢ − vQlen_oldᵢ)/b2
    if (Mfair^{C}ᵢ < 0) Mfair^{C}ᵢ = 0;
        Mfair_{i,j} = Min {Mfair^{C}ᵢ * Wᵢⱼ , Mmax_{i,j}}, if Mmax_{i,j} is configured
```

For each Client

```
vQlen_{i,j} = Max(0, vQlen_{i,j} + M_{i,j} − (Mfair_{i,j} >> C))
Mfair^{C}_{i,j} = Mfair^{C}_{i,j} − (vQlen_{i,j} − vQref_{i,j})/c1 −
(vQlen_{i,j} − vQlen_old_{i,j})/c2
M_{i,j,k} = Mi_{,j,k}_old *(1-1/2^{C}) + M_{i,j,k}_new
if (M_{i,j,k} < Mfair^{C}_{i,j})
    D_{i,j,k} = 0
else
    D_{i,j,k} = 1 − Mfair^{C}_{i,j}/M_{i,j,k}
```

The parameters a1, a2, b1, b2, c1 & c2 are predefined constants, with typical values of a1=b1=c1=2 and a2=b2=c2=¼. Note that all the rate counters such as Mmaxᵢ, Mᵢ etc, are actually counting bytes per averaging time interval which is equal to 2^{C}×UpdateInterval and should be appropriately initialized.

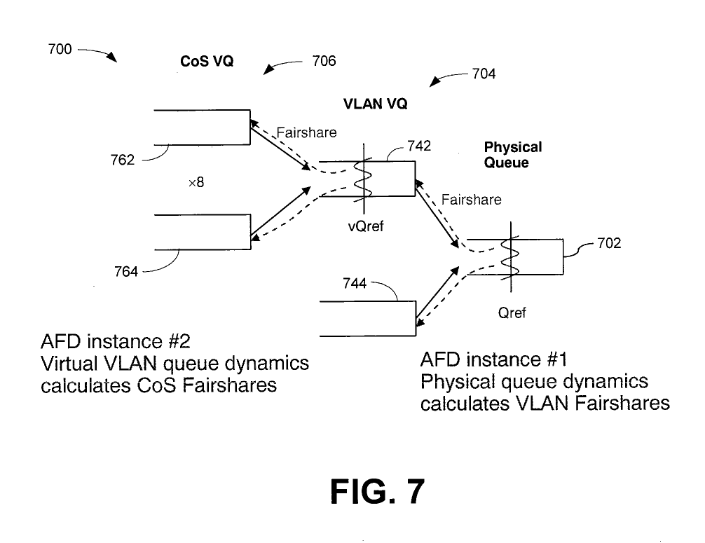

FIG. 7 illustrates an example of a logical block diagram of a wired port system 700 employing hierarchical queuing and scheduling for determining fair share bandwidths for each Class of Service. In this example embodiment, hierarchical queue scheduling logic (for example HQS logic 102 described herein in FIG. 1) computes fair share bandwidths for two stages. The first stage 704 is the fair share bandwidths for each Virtual Local Area Networks (VLAN) associated with a physical queue. The second stage 706 is the fair share bandwidth for each Class of Service (CoS) associated with each VLAN.

In an example embodiment, HQS logic (for example HQS logic 102 described in FIG. 1) determines a bandwidth for queue 702. The bandwidth may be configurable. The queue reference (Qref) is user configured.

Once the bandwidth of the queue is known, the fair share bandwidths of the VLANs (in this example VLANs 742, 744) can be determined. After the fair share bandwidths of the VLANs have been computed, the fair share bandwidths of each Class of Service (CoS) can be calculated. For example, in the illustrated example, VLAN 742 has two classes 762, 764. In an example embodiment, virtual queues are calculated for each VLAN 742, 744 and Cos 762, 764. Based on the fair share bandwidths (or virtual queues), the drop probability for each Cos 762, 764 can be determined.

In operation, as queue length of queue 702 begins to exceed the reference queue length (Qref), the bandwidth (virtual queues) of VLANs 742, 744, and Cos's 762, 764 are adjusted accordingly. The HSQ logic may track packet arrival rates for each VLAN 742, 744 and Cos 762, 764 and periodically recomputed the fair share bandwidths (virtual queue reference lengths) for VLANs 742, 744 and Cos's 762, 764.

When a packet is received, the CoS and/or VLAN for the packet is determined. If the current bandwidth of queue 702 is less than the queue bandwidth (e.g. the queue length is less than or equal to Qref). If, however, the current bandwidth of queue 702 is greater than the queue bandwidth (e.g., the queue length is greater than Qref), then the packet may be dropped based on a calculated drop probability based on the drop probability for the packet's class of service. In particular embodiments, the packet may be dropped based on a drop probability for the VLAN associated with the packet. If the packet is enqueued, packet arrival rates (for example counters) for the CoS and VLAN of the packet are updated.

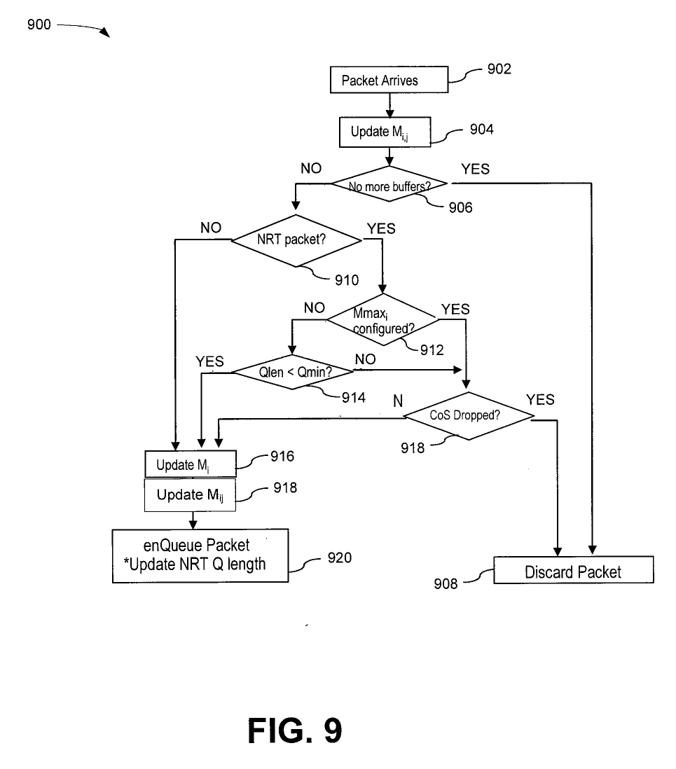

In view of the foregoing structural and functional features described above, methodologies in accordance with example embodiments will be better appreciated with reference to FIGS. 8 and 9. While, for purposes of simplicity of explanation, the methodologies of FIGS. 8 and 9 are shown and described as executing serially, it is to be understood and appreciated that the example embodiments are not limited by their illustrated orders, as some aspects could occur in different orders and/or concurrently with other aspects from that shown and described herein. Moreover, not all illustrated features may be required to implement the methodologies described herein in accordance with aspects of example embodiments. The methodologies described herein are suitably adapted to be implemented in hardware, software, or a combination thereof.

FIG. 8 illustrates an example of a method 800 for determining a drop probability for a wired port system employing hierarchical queue scheduling.

At 802, a reference queue length is determined for the physical queue. The reference queue length may be a default length (such as 50% of the total queue size) or may be a configurable value. In addition, a queue bandwidth may be determined.

At 804, the current queue length is determined. As used herein, the current queue length refers to the amount of space in the queue that is occupied (for example a number of bytes or % of the total queue that is occupied).

At 806, Virtual Local Area Network (VLAN) fair shares (fair share bandwidth) are calculated. The fair shares are a function of the occupancy of the physical queue. For example, as queue occupancy increases, transmitter fair shares decreases.

At 808, VLAN virtual queue lengths are calculated. Transmitter virtual queue length may be calculated from actual arrivals and departures (e.g. fair share bandwidth)

At 810, Class of Service (CoS) fair shares are calculated. The Cos fair shares are a function of the VLAN virtual queue. In particular embodiments, a weighting algorithm may be employed for determining the CoS fair shares (for example a first CoS may get ⅓ of the available bandwidth for the VLAN while the second service set may get ⅔ of available bandwidth).

At 812, average CoS arrival rates are determined. The average CoS arrival rates can be calculated based on time-window averaging.

At 814, CoS drop probabilities are calculated. The CoS drop probabilities may be calculated form the average CoS arrival rates and CoS fare share rates. If the arrival rate is below the fair share rate, the drop probability is zero. If the average arrival rate is more than the minimum of the fair share rate or the configured maximum rate for the CoS, the drop probability is proportional to the amount that the average arrival rate is in excess of the minimum of the fair share rate or the configured maximum rate.

Below is an example of pseudo code for implementing a methodology in accordance with an example embodiment. In an example embodiment, the methodology can be executed periodically (for example every 1.6 milliseconds). In this example, the variables are as follows:

For the physical queue:
Qlen_NRT: Non-real time queue length;
Qref: Reference Qlen for NRT queue;
Qmin: Minimum Qlen below which fast up convergence may be applied and packet drop may be disabled
Mfair^{C}: Common Fair Rate;
Mmax: Max port shaped rate;

For VLAN Virtual Queue
Mᵢ: arrival rate for ith VLAN
Wᵢ: weight for ith VLAN
Mfairᵢ: Fair Rate for ith VLAN
Mmaxᵢ: Max rate for ith VLAN
VQlenᵢ: virtual queue length for ith VLAN
VQrefᵢ: reference virtual Qlen
Mfair^{C}ᵢ: VLAN Common Fair Rate

For CoS Flows
M_{i,j}: arrival rate for jth CoS of ith VLAN
W_{i,j}: weight for jth CoS of ith VLAN
D_{i,j}: Drop Probability for jth CoS of ith VLAN
Mmax_{i,j}: Max rate for jth CoS of ith VLAN

For stage 1 (VLAN stage):

```
Mfair^{C} = Mfair^{C} − (Qlen_total − Qref)/a1 −
(Qlen_total_Qlen_total_old)/a2
If (Mfair^{C} < 0) Mfair^{C} = 0
    if (tail_drop_occurred)
        Mfair^{C} = Mfair^{C} − Mfair^{C} >> fast_down
    else if (Qlen < Qmin)
        Mfair^{C} = Mfair^{C} + Mfair^{C} >> fast_up
Mfairᵢ = Min {Mfair^{C} * Wᵢ , Mmaxᵢ}
```

Parameter Settings:
vQlenᵢ is instantaneous virtual VLAN queue length
vQrefᵢ=W′ᵢ*Qref

For stage 2 (CoS stage):

```
vQlenᵢ = Max(0, vQlenᵢ + Mᵢ − (Mfairᵢ >>C))
Mfair^{C}ᵢ = Mfair^{C}ᵢ − (vQlenᵢ − vQrefᵢ)/b1 − (vQlenᵢ − vQlen_oldᵢ)/b2
if (Mfair^{C}ᵢ < 0); Mfair^{C}ᵢ = 0
Mfair_{i,j} = Min {Mfair^{C}ᵢ * W′_{i,j} , Mmax_{i,j}}
M_{i,j} = M_{i,j}_old *(1-1/2^{C}) + M_{i,j}_new
if (M_{i,j} > Mfair_{i,j})
    D_{i,j} = 1 − Mfair_{i,j}/M_{i,j}
else
    D_{i,j} = 0
```

FIG. 9 illustrates an example of a method 900 for determining whether to enqueue or drop a packet for a queue employing hierarchical queue scheduling.

At 902, a packet arrives. The packet may be a real time (RT) packet or non-real time (NRT) packet. Packet classification logic determines the type of packet (real time or non-real time) and a VLAN and CoS for sending the packet.

At 904, a counter associated with the client for the packet is updated. In the illustrated example, the counter is Mᵢⱼ, where i=the VLAN, j=CoS of the jth class of VLANᵢ. The counters can be employed for determining client packet arrival rates.

At 906, a determination is made whether there are available buffers for the packet (No more buffers?). If there are no buffers (YES), at 908 the packet is discarded (dropped). If there are buffers (NO), at 910 a determination is made whether the packet is a non-real time (NRT) packet.

If, at 910, a determination is made that the packet is not a non-real time packet (NO), or in other words the packet is a real time packet (for example a voice or video packet as illustrated in FIG. 4), at 916 the counter for the VLAN (Mᵢ) is updated, at 918 the counter for the CoS (Mᵢⱼ) is updated, and at 920 the packet is enqueued and the Non-real time queue length (Qlen) is updated.

If at 910 it was determined that the packet was a non-real time (NRT) packet, at 912 it is determined whether a maximum arrival rate (Mmaxi) was configured for the VLAN. If the maximum arrival rate for the VLAN was configured (YES), at 918 a determination is made whether to enqueue or drop the packet based on the CoS drop probability. If, at 918, it is determined that the packet should be dropped, the packet is dropped (discarded) as illustrated at 908.

If at 912, the determination is made that the maximum arrival rate has not been configured for the VLAN (NO), at 914 a determination is made whether the virtual queue length is greater than the minimum reference queue Qmin. If at 914, the determination is made that the queue length is greater than the minimum reference queue length (NO), at 918, a determination is made whether to enqueue or drop the packet based on the Cos drop probability. If, at 918, it is determined that the packet should be dropped, the packet is dropped (discarded) as illustrated at 908. If, however, at 918, the determination is made to enqueue the packet, at 916 the counter for the VLAN (Mᵢ) is updated, at 918 the counter for the CoS (Mᵢⱼ) is updated, and at 920 the packet is enqueued and the Non-real time queue length (Qlen) is updated.

If at 914, the determination is made that the queue length is less than the minimum reference queue length (YES), the packet will be enqueued. Thus, at 916 the counter for the VLAN (Mᵢ) is updated, at 918 the counter for the CoS (Mᵢⱼ) is updated, and at 920 the packet is enqueued and the Non-real time queue length (Qlen) is updated.

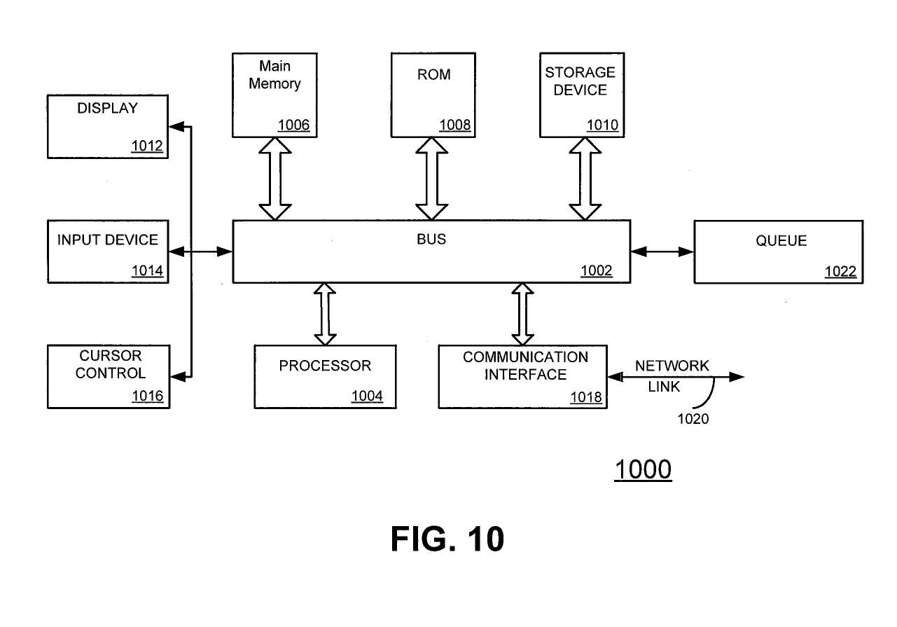

FIG. 10 illustrates a computer system 1000 upon which an example embodiment can be implemented. Computer system 1000 includes a bus 1002 or other communication mechanism for communicating information and a processor 1004 coupled with bus 1002 for processing information. Computer system 1000 also includes a main memory 1006, such as random access memory (RAM) or other dynamic storage device coupled to bus 1002 for storing information and instructions to be executed by processor 1004. Main memory 1006 also may be used for storing a temporary variable or other intermediate information during execution of instructions to be executed by processor 1004. Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

In an example embodiment, computer system 1000 may be coupled via bus 1002 to a display 1012 such as a cathode ray tube (CRT) or liquid crystal display (LCD), for displaying information to a computer user. An input device 1014, such as a keyboard including alphanumeric and other keys is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g. x) and a second axis (e.g. y) that allows the device to specify positions in a plane.

An aspect of the example embodiment is related to the use of computer system 1000 for hierarchical queueing and scheduling. According to an example embodiment, hierarchical queueing and scheduling is provided by computer system 1000 in response to processor 1004 executing one or more sequences of one or more instructions contained in main memory 1006. Such instructions may be read into main memory 1006 from another computer-readable medium, such as storage device 1010. Execution of the sequence of instructions contained in main memory 1006 causes processor 1004 to perform the process steps described herein. One or more processors in a multi-processing arrangement may also be employed to execute the sequences of instructions contained in main memory 1006. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 1004 for execution. Such a medium may take many forms, including but not limited to non-volatile media and volatile media. Non-volatile media include for example optical or magnetic disks, such as storage device 1010. Volatile media include dynamic memory such as main memory 1006. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read. As used herein, a tangible media includes volatile media and non-volatile media.

In an example embodiment, computer system 1000 comprises a communication interface 1018 coupled to a network link 1020. Communication interface 1018 can receive packets for queuing. Processor 1004 executing a program suitable for implementing any of the example embedment described herein can determine whether the packet should be enqueued into queue 1022 or dropped.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

Note in the example embodiments described herein there were listed some “typical” values for parameters, for example an interval of 1.6 ms for periodically executing the algorithm. These values are applicable to an example embodiment and may vary based variables such as port speed (1 Gbps) and the amount of buffers implemented. This value can be changed, and in particular embodiments may be changed within a small range, e.g., +/−30%.

1. A method, comprising:
determining a bandwidth for a queue;
allocating bandwidth to first and second transmitters coupled to the queue, wherein the bandwidth allocated to each of the first and second transmitters is a portion of the queue bandwidth;
determining a bandwidth allocation for a first plurality of clients associated with the first transmitter, wherein bandwidth allocated to each of the first plurality of clients is a portion of the bandwidth allocated to the first transmitter;
determining a bandwidth allocation for a second plurality of clients associated with a second transmitter, wherein the bandwidth allocated to each of the second plurality of clients is a portion of the bandwidth allocated to the second transmitter;
maintaining a packet arrival count for each of the first plurality of clients and second plurality of clients; and
determining a drop probability for each of the first plurality of clients and the second plurality of clients based on the packet arrival count corresponding to each client and bandwidth allocated for each client.

2. The method according to claim 1, wherein a first subset of the first plurality of clients belong to a first service set associated with the first transmitter, and a second subset of the first plurality of clients belong to a second service set associated with the first transmitter, wherein the determining bandwidth allocation for the first plurality of clients further comprises:
determining a first service set bandwidth allocation for the first service set that is a portion of the bandwidth allocated to the first transmitter;
determining a second service set bandwidth allocation for the second service set that is a portion of the bandwidth allocated to the first transmitter;
determining a bandwidth allocation for each of the first subset of the first plurality of clients, wherein the bandwidth allocation for each client belonging to the first subset of the first plurality of clients is a portion of the first service set bandwidth allocation; and
determining a bandwidth allocation for each of the second subset of the second plurality of clients, wherein the bandwidth allocation for each client belonging to the second subset of the second plurality of clients is a portion of the second service set bandwidth allocation.

3. The method according to claim 1, further comprising:
selecting a reference queue length;
determining a virtual queue length for the first transmitter based on the bandwidth allocated to the first transmitter and the reference queue length; and
determining a virtual queue length for the second transmitter based on the bandwidth allocated to the second transmitter and the reference queue length.

4. The method according to claim 3, further comprising monitoring a current queue length of the queue; and
wherein maintaining a packet arrival count further comprises maintaining a packet arrival count for the first transmitter and the second transmitter.

5. The method according to claim 4, further comprising
periodically adjusting the virtual queue length for the first transmitter responsive to changes in the current queue length;
periodically adjusting the virtual queue length for the second transmitter responsive to changes in the current queue length;
adjusting the bandwidth allocation for the first plurality of clients responsive to adjusting the virtual queue length for the first transmitter;
adjusting the bandwidth allocation for a second plurality of clients responsive to adjusting the virtual queue length of the second transmitter; and
adjusting the drop probability for each of the first plurality of clients responsive to adjusting the bandwidth allocation for the first plurality of clients; and
adjusting the drop probability for each of the second plurality of clients responsive to adjusting the bandwidth allocation for the second plurality of clients.

6. The method according to claim 1, wherein the drop probability employs an approximate fair dropping algorithm.

7. The method according to claim 1, further comprising
receiving a packet for a real-time queue associated with a client; and
updating the packet arrival count for the client.

8. The method according to claim 1, a first service set selected from a plurality of service sets is associated with the first transmitter, and the first plurality of clients belong to the first service and the second plurality of clients belong to the first service set, the method further comprising:
determining a first service set bandwidth allocation for the first service set that is a portion of the bandwidth allocated to the first transmitter;
wherein determining a bandwidth allocation for each of the first plurality of clients is based on the first service set bandwidth allocation; and
wherein determining a bandwidth allocation for each of the second plurality of clients is based on the first service set bandwidth allocation.

9. Logic encoded in at least one tangible media for execution and when executed operable to:
receive a packet;
determine a client associated with the packet, the client selected from a plurality of clients, the selected client belonging to a service set selected from a plurality of service sets, the service set belonging to a transmitter selected from a plurality of transmitters, and the plurality of transmitters sharing a queue;
determine a drop probability for the selected client;
determine a current packet arrival rate for the selected client; and
determine whether to enqueue or drop the packet based on the drop probability for the selected client and the current packet arrival rate associated with the selected client;
wherein the drop probability is based on a packet arrival rate and virtual queue length for the selected client, which is based on a packet arrival rate and virtual queue length for the selected service set that is based on a packet arrival rate and virtual queue length for the selected transmitter.

10. Logic set forth in claim 9, further operable to update a counter for determining the packet arrival rate for the selected client, update a counter for determining the packet arrival rate for the selected service set, and update a counter for determining the packet arrival rate for the selected transmitter responsive to determining to enqueue the packet.

11. Logic set forth in claim 9, further operable to:
determine a change in queue length over a period;
determine a packet arrival rate for the queue over the period;
adjust a transmitter virtual queue length for the queue based on the change in queue length and packet arrival rate for the queue;
adjust the virtual queue length for the selected service set responsive to adjusting the virtual queue length for the queue; and
adjust the virtual queue length for the client responsive to adjusting the virtual queue length for the service set.
Logic set forth in claim 11, further operable to reset the packet arrival rate for the queue, a packet arrival rate for the transmitter, a packet arrival rate for the selected service set, and the packet arrival rate for the client after the period expires.

12. Logic set forth in claim 11, further operable to:
adjust a bandwidth allocated for the transmitter based on the change in queue length;
adjust a bandwidth for the selected service set based on the adjusted transmitter virtual queue; and
adjust a bandwidth for the selected client based on the adjusted virtual queue length for the selected service set.

13. Logic set forth in claim 9, wherein the queue is a non-real time queue, the logic is further operable to enqueuing a packet for a real time queue associated with the selected client to update a counter for determining the packet arrival rate for the selected client, update a counter for determining the packet arrival rate for the selected service set, and update a counter for determining the packet arrival rate for the selected transmitter.

14. An apparatus, comprising:
a queue;
hierarchical queue scheduling logic coupled to the queue;
wherein the hierarchical queue scheduling logic is configured to maintain arrival counts by transmitter, service set and client for packets received for the queue;
wherein the hierarchical queue scheduling logic is configured to allocate a bandwidth for at least one transmitter servicing the queue based on a packet arrival count for packets received for the at least one transmitter and changes to queue occupancy;
wherein the hierarchical queue scheduling logic is configured to determine a bandwidth allocation for at least one service set associated with the at least one transmitter, the bandwidth allocation for the at least one service set is based on a virtual queue length for the at least one transmitter;
wherein the hierarchical queue scheduling logic is configured to determine a bandwidth allocation for at least one client associated with the at least one service set based on a virtual queue length for the at least one service set; and
wherein the hierarchical queue scheduling logic is configured to determine a client drop probability for the at least one client based on a packet arrival rate for the at least one client and bandwidth allocation for the at least one client.

15. The apparatus set forth in claim 14, wherein the hierarchical queue scheduling logic is responsive to receiving a packet to determine a client, service set, and transmitter for servicing the packet;
wherein the hierarchical queue scheduling logic is further configured to update the arrival count and drop probability for the client responsive to receiving the packet;
wherein the hierarchical queue scheduling logic is configured to determine whether to enqueue the packet based on the drop probability;
wherein the hierarchical queue scheduling logic is further configured to update the arrival count for the service set and transmitter responsive to determining to enqueue the packet; and
wherein the hierarchical queue scheduling logic forwards the packet to the queue responsive to determining to enqueue the packet.

16. The apparatus set forth in claim 14, wherein the hierarchical queue scheduling logic is responsive to receiving a packet to determine a client, service set, and transmitter for servicing the packet;
wherein the hierarchical queue scheduling logic is further configured to update the arrival count and drop probability for the client responsive to receiving the packet;
wherein the hierarchical queue scheduling logic is configured to determine whether to drop the packet based on the drop probability; and
wherein the hierarchical queue scheduling logic is further configured to discard the packet responsive to determining to drop the packet.

17. Logic encoded in at least one tangible media and when executed operable to:
determine a bandwidth for a queue coupled to the logic;
determine a fair share bandwidth for each Class of Service associated with the queue that comprises calculating fair share bandwidths for each Virtual Local Area Network coupled to the queue, the fair share bandwidth of each Virtual Local Area Network is based on a weighting factor and the bandwidth of the queue, and
the determining a fair share bandwidth for each Class of Service further comprises for each Virtual Local Area Network, calculating a fair share bandwidth for each Class of Service associated with each Virtual local area network, wherein the fair share bandwidth of each Class of Service is a portion of the fair share bandwidth of its associated Virtual Local Area Network.

18. Logic according to claim 17, further operable to periodically recalculate the fair share bandwidth for each Virtual Local Area Network and each Class of Service.

19. Logic according to claim 17, further operable to determine a drop probability for a Class of Service based on a current packet arrival rate for the Class of Service and the fair share bandwidth for the Class of Service.

20. Logic according to claim 19, further operable to:
receive a packet for the queue;
determine a Class of Service associated with the packet;
determine whether to enqueue or drop the packet based on the drop probability for the Class of Service associated with the packet.

21. A method, comprising:
determining a reference queue length for a queue;
determining a queue length for the queue;
determining a first virtual queue length for a first Virtual Local Area Network coupled to the queue;
determining a first reference virtual queue length for the first Virtual Local Area Network;
determining a second virtual queue length for a second Virtual Local Area Network coupled to the queue;
determining a second reference virtual queue length for the second Virtual Local Area Network;
determining a maximum rate for a Class of Service associated with the first Virtual Local Area Network;
determining a current packet arrival rate for the Class of Service; and
determining a drop probability for the Class of Service based on the packet arrival rate and maximum rate for the class of service.

22. The method set forth in claim 21, further comprising periodically adjusting the drop probability for the class of service, the periodically adjusting comprises:
determining a current queue length for the queue;
adjusting the virtual queue length for the first Virtual Local Area Network responsive to a change in queue length;
adjusting the drop probability for the Class of Service responsive to a change in the virtual queue length for the first Virtual Local Area Network.

23. The method set forth in claim 21, further comprising:
maintaining a count of packets received for the first Virtual Local Area Network; and
maintaining a count of packets received for the Class of Service.

24. The method set forth in claim 23, further comprising:
determining a packet arrival rate for the first Virtual Local Area network based on the count of packets received for the first Virtual Local Area Network; and
determining a packet arrival rate for the Class of Service based on the count of packets received for the Class of Service.

25. The method set forth in claim 24, further comprising:
determining a fair share rate for the first Virtual Local Area Network;
adjusting the first virtual queue length based on the fair share rate for the first Virtual Local Area Network and the packet arrival rate for the first Virtual Local Area Network;
adjusting the maximum rate for the Class of Service based on the adjustment to the first virtual queue length; and
adjusting the drop probability for the Class of Service based on the adjusted maximum rate and packet arrival rate for the Class of Service.
